(19) United States
(12) Patent Application Publication
(10) Pub. No.: US 2015/0081436 A1
(43) Pub. Date: Mar. 19, 2015

(54) Method and System for Determining a Next Best Offer

(71) Applicant: Acxiom Corporation, Little Rock, AR (US)

(72) Inventors: Dana S. Robbins, Conway, AR (US); Vivek Palan, San Francisco, CA (US); Lik Mui, Hayward, CA (US); Gabrielle Tao, San Mateo, CA (US)

(21) Appl. No.: 14/478,994

(22) Filed: Sep. 5, 2014

Related U.S. Application Data
(60) Provisional application No. 61/879,398, filed on Sep. 18, 2013.

(51) Int. Cl. G06Q 30/02

(52) U.S. Cl. CPC G06Q 30/0255
USPC 705/14.53

(57) ABSTRACT

A method and system for determining a next best offer utilizes a data layer, two consumer data hubs, and a decision engine. The data layer includes numerous sources of consumer data, such as transaction data, past campaign response data, demographic data, predictive or propensity data, and real-time data such as website clickstreams. Separate consumer data hubs are used for data records that include personally identifiable information (PII) and those that do not. By using separate data hubs in this manner, online anonymous data may be used for targeting marketing, but this data may be maintained separately from PII data in order to ensure that the privacy of the consumer is protected.

### CROSS-REFERENCE TO RELATED APPLICATIONS

This application claims the benefit of U.S. provisional patent application No. 61/879,398, filed on Sep. 18, 2013, and entitled “Method and Apparatus for Determining a Next Best Offer.” Such application is incorporated herein by reference in its entirety.

### STATEMENT REGARDING FEDERALLY SPONSORED RESEARCH OR DEVELOPMENT

Not applicable.

### BACKGROUND OF THE INVENTION

Marketers, who either offer goods or services for sale themselves or provide marketing services to those who sell goods or services, often find it desirable to provide a “next best offer,” that is, a follow-up offer to a customer or potential customer after an initial contact with the relevant consumer has been made. The art includes a number of methods by which such follow-up or next best offers can be made when the identity of the consumer is known. These may include a marketing message that is targeted to the consumer based upon information that is either known or that may be determined based on the identity of the consumer. For example, a retailer may have a marketing database in which it maintains various data about each of its customers. Personally identifiable information (PII) about those customers, such as name, address, telephone number, and email address, may be used to match that data with other information about those customers that is provided to the customer by third parties. Such third parties may include a marketing services provider that maintains a large database with demographic, segment, purchase history, purchase propensities, and other data related to each of a large group of consumers in a particular geographic area that the marketer serves. This information can be used to tailor a marketing message to the consumer's particular interests or towards those products and services that are more likely to be of interest to consumers with a particular profile. For example, a consumer that recently moved to a larger home may be more likely to be interested in a discount offer related to home furnishings, while a new parent may be more likely to respond to a marketing message concerning baby strollers.

While this type of targeted advertising is common in regards to “offline” data, that is, data that is collected other than through web browsing and other Internet-based sources, PII about a customer reached through online channels may not be known by the marketer. For example, a customer who reaches a marketer through an Internet search engine result or a social media channel often has not revealed any PII to the marketer. The only contact between the retailer and the consumer may be an advertisement displayed on a third-party website. Although in certain online situations the consumer may “log in” or otherwise provide PII to the marketer, this is often not the case prior to the consumer's decision to make a purchase. Further, use of PII in online marketing channels may be limited by various laws and regulations, or by marketing industry best practices that are designed to safeguard the privacy of the consumer. Any attempt to deliver a next best offer in an online, multi-channel marketing environment must ensure that PII of the consumer, if used at all, is not used in any manner that would compromise the privacy of the consumer. The ability to deliver a targeted next best offer in an online marketing environment as part of an overall multichannel marketing effort that does not risk a loss of privacy for the consumer would be highly desirable.

### BRIEF SUMMARY OF THE INVENTION

The present invention in certain embodiments solves the problems described above by enabling a marketer to provide a next best offer to a consumer without the use of PII, and is particularly useful in online marketing channels were PII may not be available or its use is restricted in order to protect the privacy of the consumer. Separate consumer hubs are used for PII data and anonymous data, so that the anonymous targeted marketing messages may be incorporated into an overall multichannel marketing effort. A data layer feeds data through the separate consumer hubs and to a decision engine that provides marketing services to marketers.

The invention allows the retailer or other marketer to target an advertisement to a consumer, yet the marketer is never provided with PII about that consumer, thus ensuring that the consumer's privacy is protected. The invention improves the return on investment of advertising for the marketer since marketing messages that are targeted to the consumer are more likely to elicit a positive response from the consumer. Likewise, the invention benefits consumers because the consumers are given marketing messages that are more likely to be of interest and benefit to them, rather than being delivered marketing messages that are not relevant and of no interest. The next best offer functionality of the various embodiments of the present invention are made possible by the use of anonymous links, which link to certain types of information about a particular consumer but do not link to any PII, and thus provide no PII to the marketer.

The present invention provides marketers with the opportunity to make offers or recommendations in a wide range of possible marketing scenarios. These include a primary or first offer to the consumer, as well as a secondary or next best offer after the primary offer is rejected. The invention allows for the deliver of such offers in an online marketing channel regardless of whether the consumer has actually logged in or registered or otherwise provided identifying information to an online site, and regardless of whether the customer has logged in or registered at the online site in a previous visit. Further, the invention is useful for targeting marketing messages regardless of whether the consumer is an existing customer or a pure prospect.

These and other features, objects and advantages of the present invention will become better understood from a consideration of the following detailed description of certain embodiments and appended claims in conjunction with the drawings as described following:

### BRIEF DESCRIPTION OF THE SEVERAL VIEWS OF THE DRAWINGS

FIG. 1 is a diagram showing a networked system according to certain embodiments of the present invention.

FIG. 2 is a diagram showing functional components of a system according to certain embodiments of the present invention.

FIG. 3 is a diagram showing connected computing devices in an implementation of certain embodiments of the present invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

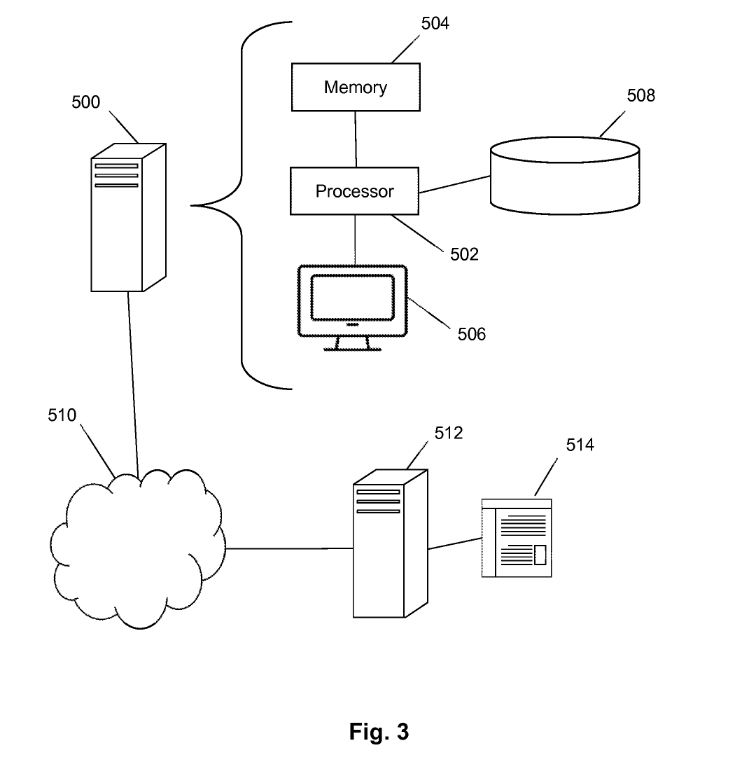

In the various embodiments of the invention described herein, several parties may be involved in multichannel marketing and analysis. These parties include a marketing services provider, who provides services that enable the tracking of user (consumer) engagement as described herein; marketers who are promoting their products or services via websites, social media sites, display advertisements, print advertisements, and packaging; agencies working for marketers in order to provide them with marketing support services (who may provide none, some, or all of the services described herein with respect to marketers); content publishers such as news, entertainment, and other websites that include advertisements in their content as, for example, a source of revenue or to advertise their own products or services (in which case they may also be marketers); and the consumers who ultimately purchase the goods and services offered by the marketers through various online and offline channels. Each of these parties may operate computing devices that are interconnected over the Internet. The marketing services provider, marketer, publisher, and agencies may use specially programmed computer servers to provide the various functionality described herein. Consumers may access the various components of this system utilizing consumer computing devices capable of accessing the Internet, including but not limited to devices such as desktop computers, laptop computers, tablets, and smartphones, as well as other types of web-connected, embedded devices, such as televisions, thermostats, and appliances. Certain of these components are further described below with reference to FIG. 3.

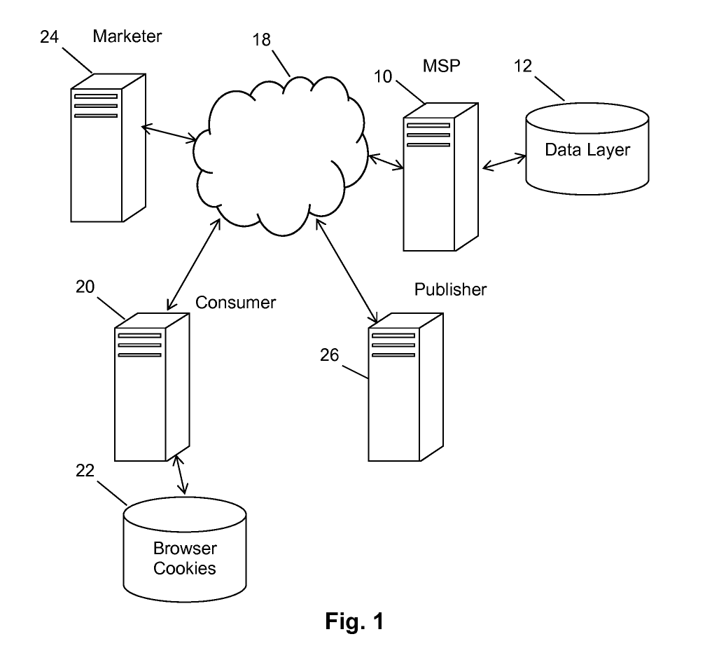

A system for implementing the invention as described herein is depicted in FIG. 1. Marketing services provider (MSP) 10 provides a data layer 12 in which it maintains both PII and segregated non-PII data for use of the various embodiments of the invention. Because data layer 12 contains areas that contain no PII, data maintained here may be used in ways that otherwise would not be possible for online marketing transactions. Data in data layer 12 is stored in records, each of which is linked by a consumer link for information connected to PII, and an anonymous link for non-PII data. The anonymous link is not used for linking consumer data in other databases or data storage areas that include PII, even other areas operated by the MSP. In this manner, a party that gains access to the anonymous link for any consumer will be unable to use the anonymous link in order to surreptitiously identify the consumer about whom the data pertains, and cannot use the anonymous link as a means of actually discerning the individual consumer.

Prior to use of the various embodiments of the invention, data layer 12 is populated with data from one or more sources. These sources may include information collected by the MSP that may be originally placed in data layer 12 or be pulled from other databases that the MSP maintains; from the marketer to whom the MSP is providing services, such as its own internal customer databases; from an agency representing the marketer; or from third parties that maintain their own consumer databases. This data may include, for example, many types of demographic information. In the case of information from the marketer, it may include information that would only be known by the marketer, such as how frequently a customer purchases from the marketer, or how long it has been since the consumer has purchased from the marketer. Specific examples include various transactional data; past campaign response data; demographic data; proprietary data collected or created (such as purchase propensities) by the MSP; and real-time data, such as website clickstreams. Since this information is linked only by the anonymous link and not connected with any PII after data layer 12 is populated in the non-PII section, there is no risk of a loss of privacy for any consumer for online transactions where PII is not allowed, despite the depth and breadth of data that data layer 12 may contain in various embodiments.

MSP 10 is in communication with marketer 24, which is in electronic communication over network 18 with one or more consumers 20. Consumers 20 each are communicating with marketer 24 through a consumer computing device. The consumer computing device includes a browser with browser cookies 22 that have been accumulated through web browsing by consumer 20. These cookies may be accessed by software associated with a website when a consumer clicks on an associated link during a web browsing session. MSP 10 and consumers 20 are further interconnected in electronic communication over network 18 with publisher 26, each of which maintains content that is accessible by a web browser operated by each consumer 20.

There may be any number of marketers 24 who participate in the services provided by MSP 10. In various embodiments, MSP 10 may maintain separate secure areas 12 for each marketer, in order to facilitate the use of data from each marketer in processing for that particular marketer, while preventing the sharing of data between marketers or the direct or indirect use by one marketer of data provided by another marketer.

There may be any number of publishers 26, such as the thousands or even millions of websites currently accessible to consumers over the Internet and which use third-party advertising as one or the only means of monetizing the content that they provide. Publishers 26 may broadly include not only those parties that operate websites that directly provide marketing information related to products and services, but also those that provide links to this information, such as social media sites that maintain online conversations between consumers.

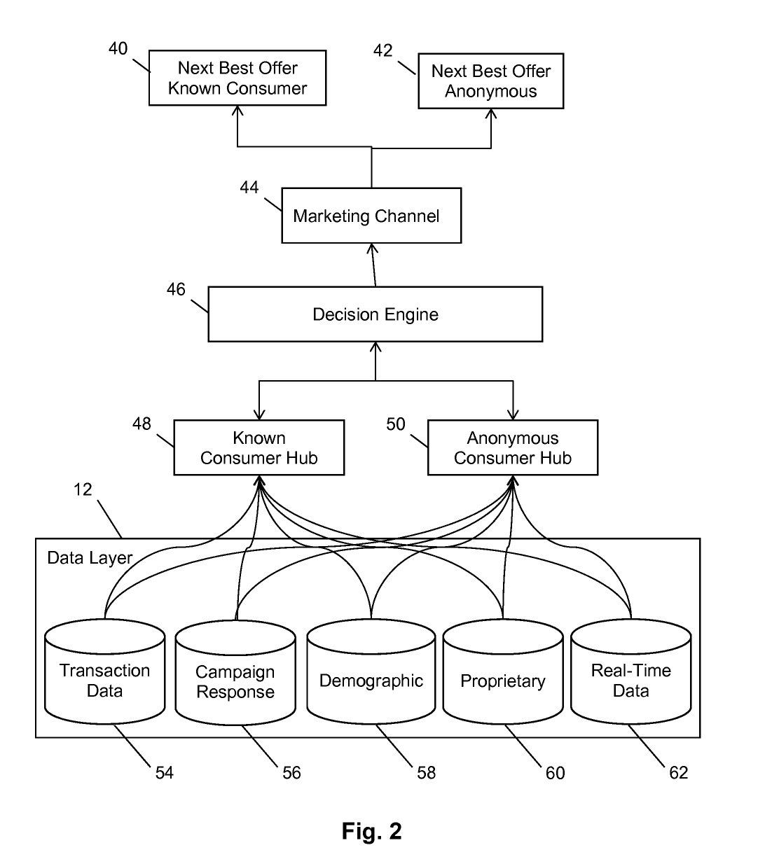

Turning now to FIG. 2, a structure for providing a next best offer according to certain embodiments of the invention may be described. The structure includes three main components that work together in order to provide all of the various processing described herein. A data layer 12; consumer hubs 48 and 50, and a decision engine 46. The embodiments shown allow for “1^{st} party” marketing campaigns, that is, marketing campaigns that are conducted on a particular marketer's own branded channels such as its own website, as well as “3^{rd} party” marketing campaigns, where the channels through which the marketing message are presented are not owned or controlled by the marketer itself, but are instead based on a partnership arrangement between these two. Data from both online (channels that require an Internet connection) and offline (channels that do not require an Internet connection) may be utilized. Targeted marketing messages may be delivered using both known users (with PII) where the consumer has voluntarily offered identifying information, such as a name, address, email, or log-in information, as well as anonymous users, where the targeting is based on an identity that the user has not knowingly offered to a marketer or other party, such as based on a cookie.

Cookies may be stored in a web browser operated from consumer device 20 in browser cookies 22, as depicted in FIG. 1. When a website operated by the publisher or otherwise associated with the marketer is visited, cookies 22 may be searched in order to determine if a cookie set by the MSP is found there. This cookie, if found, is retrieved for further processing. The MSP cookie contains the anonymous link, which is used to find information in anonymous consumer hub 50 associated with a consumer. Setting of the MSP cookie in browser cookies 22 occurs prior to the processing described herein. In certain embodiments, the cookie found in browser cookies 22 may not contain the anonymous link directly, but may instead contain information that allows the link to be looked up in tables maintained by the MSP. In certain embodiments of the invention, other types of identifiers for the consumer or the consumer device may be used in place of a cookie from browser cookies 22. These device identifiers may include, for example, those currently used by Google, Apple, and other companies for various purposes relating to the identification of a particular web user or a particular connected device.

The cookie from browser cookies 22 is read to return the anonymous link that is associated with the consumer operating consumer device 20. The anonymous link is in certain embodiments uniquely associated in anonymous consumer hub 50 with a particular consumer, and thus the anonymous link enables the MSP to positively and uniquely identify consumer 20, but does so without the use of any PII related to that consumer in order to facilitate processing through anonymous consumer hub 48. The term “identify” is used here in the sense of distinguishing the consumer data from data associated with others, but not necessarily to use or assign any PII such as name, address, telephone number, or email address. Using the anonymous link that was read from the cookie in the consumer's browser at browser cookies 22, anonymous consumer hub 50 may be accessed in order to recover any and all desired information that is maintained in anonymous consumer hub 50 about this consumer.

Data layer 12 consists of a number of specific types of data in various embodiments, which may be stored separately or stored in different databases, which may be connected physically or remotely from each other and connected over a network such as the Internet. These databases are used to construct known consumer hub 48 and anonymous consumer hub 50. Transaction data 54 includes data about each consumer related to the specific transaction or transactions in which such consumer has engaged with a marketer. Campaign response data 56 includes data gathered from past marketing campaign responses, whether online or offline, 1^{st} party or 3^{rd} party, known or anonymous. Demographic data 58 includes various types of demographic data about individual consumers, such as age, income range, marital status, the presence or absence of children, home ownership, and the like. Proprietary data 60 includes data from a source such as the MSP that may include comprehensive databases pertaining to a large number of consumers, predictive and/or propensity data, and data gathered from mobile platforms and social media. Real-time data 62 includes data that is gathered from real-time data sources during processing, such as through website clickstreams. In various embodiments, these data types are configurable to allow clients to configure any other data sources that may be desired for a particular marketing campaign or marketing message. Since the number of data attributes that relate to consumers is vast and growing larger, the various attributes are extensible such that marketers may define their own attributes for each data type processed through the system. Some of these attributes are derived from aggregation or computation of other attributes. This aggregation and/or computation may be performed in batch mode or real time.

Known consumer hub 48 and anonymous consumer hub 50 are built from the data in data layer 12. By separating the hubs into two separate hubs for known consumers (where PII is used) and anonymous consumers (where no PII is included), rigorous privacy protection may be enforced using the system. Known consumer hub uses data layer 12 to build a set of known consumer records that include a consumer link that is unique to each consumer along with PII, as well as various other data. Anonymous consumer hub 50 builds anonymous records that include the anonymous links that are unique for each consumer and also includes various non-PII data, but specifically excludes any PII about the consumer. Known consumer hub 48 utilizes various recognition algorithms that include the use of PII for recognition of a particular consumer, such as by login credentials, name, address, telephone number, or email address. Known consumer hub 48 supports 1^{st} party cookies for user login matching, since the marketer will often use its own cookies set on the browsers of its customers in browser cookies 22. Anonymous consumer hub 50 utilizes data where all PII is removed, with the various data sources pulled from data layer 12 through anonymous consumer hub 50 and being linked only with an anonymous link. MSP cookies containing an anonymous link are supported as described above.

Decision engine 46 offers campaign, offer, and channel definitions, such as offer eligibility rules, financial and capacity assumptions related to an offer, and contact exclusion rules, such as “do not contact” lists. Automated modeling is employed, thereby utilizing propensities and inferences. The business rules applied in decision engine 46 are in certain embodiments set to context, such as whether the offer being made is a primary offer or a next best offer after a previous offer has been rejected. Decision engine 46 may exhibit machine learning and self monitoring by comparing its own predicted conversions on marketing messages based on offer recommendations to the actual conversions. It may automatically rebuild the models as campaign response and transaction data are ingested by the system. Decision engine 46 may in various embodiments operate in batch mode or real time. In batch mode, decision engine 46 calculates the next best offers for a group of consumers based on all data or a subset of all data known about those consumers at a point in time, and then pushes those offers to outbound marketing channels. Real-time operation includes operations where the system calculates the next best offer simultaneously as a customer is interacting with a marketing channel.

It may be seen from the foregoing description that the various embodiments of the invention may increase the likelihood of a consumer logging in at a marketer site or a related site to the marketer, and further increase the likelihood of a consumer having a deeper interaction with the marketing channel of interest. The marketer may use the system to offer more relevant bundled offers with special pricing that is likely to maximize profit while meeting a customer's needs more effectively. The marketer gains the ability to cross-sell more effectively with products that match the tastes and/or interests of the consumer. The system provides useful alternatives to the consumer if the marketer's primary recommendations to that consumer are rejected.

In certain specific examples, transaction data 54 may be used to provide data of successful past purchases, in order to identify combinations of products that are most often bought by the same consumer or bought together in order to create a more effective next best offer. Demographic data 58 may be used to separate data from past transactions according to behavioral characteristics of particular consumers. Real-time data 62 such as website clickstream data may be used to determine the type of websites that a particular consumer has visited, to determine which offers may have been made or products or services considered by a consumer where no purchase was in fact made. These lead to inferences at decision engine 46 such as, for a certain segment, what products are likely to be considered based on a current product under consideration; given a product purchase, what products have been bought within a certain previous timeframe; and if a consumer rejects a certain offer, what next best offer should be made to increase the likelihood of a positive response.

The preferred embodiment of the invention is implemented as a number of computing devices 500 as illustrated in FIG. 3, each of which is programmed by means of instructions to result in a special-purpose computing device to perform the various functionality described herein. This is, for example, the manner in which the marketing services provider, marketer, publisher, and agencies provide the various functionality of each of their components as described above with reference to FIG. 1. Computing device 500 may be physically implemented in a number of different forms. For example, it may be implemented as a standard computer server as shown in FIG. 3 or as a group of servers, operating either as serial or parallel processing machines.

Computing device 500 includes in the server example of FIG. 3 microprocessor 502, memory 504, an input/output device or devices such as display 506, and storage device 508, such as a solid-state drive or magnetic hard drive. Each of these components is interconnected using various buses or networks, and several of the components may be mounted on a common PC board or in other manners as appropriate.

Microprocessor 502 may execute instructions within computing device 500, including instructions stored in memory 504. Microprocessor 502 may be implemented as a single microprocessor or multiple microprocessors, which may be either serial or parallel computing microprocessors.

Memory 504 stores information within computing device 500. The memory 504 may be implemented as one or more of a computer-readable medium or media, a volatile memory unit or units such as flash memory or RAM, or a non-volatile memory unit or units such as ROM. Memory 504 may be partially or wholly integrated within microprocessor 502, or may be an entirely stand-alone device in communication with microprocessor 502 along a bus, or may be a combination such as on-board cache memory in conjunction with separate RAM memory. Memory 504 may include multiple levels with different levels of memory 504 operating at different read/write speeds, including multiple-level caches as are known in the art.

Display 506 provide for interaction with a user, and may be implemented, for example, as an LCD (light emitting diode) or LCD (liquid crystal display) monitor for displaying information to the user, in addition to a keyboard and a pointing device, for example, a mouse, by which the user may provide input to the computer. Other kinds of devices may be used to provide for interaction with a user as well.

Various implementations of the systems and methods described herein may be realized in computer hardware, firmware, software, and/or combinations thereof. These various implementations may include implementation in one or more computer programs that are executable and/or interpretable on a programmable system including at least one programmable microprocessor 502, which may be special or general purpose, coupled to receive data and instructions from, and to transmit data and instructions to, a storage system, one or more input device, and one or more output device.

The computing system can include a consumer computing device, such as a desktop computer, laptop computer, tablet, smartphone, or embedded device. In the example of FIG. 3, a desktop computer is shown. In this case, client device 512 is the consumer computing device, and runs a web browser 514 in order to access the Internet 510, which allows interconnection with computing device 500 such as operated by the MSP, marketer, and publisher. A client and server are generally remote from each other and typically interact through a communication network.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and subcombinations possible of the group are intended to be individually included. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A system for determining a next best offer, comprising:
a. a data layer comprising a plurality of data sources concerning a plurality of consumers;
b. a known consumer data hub in communication with the data layer, wherein the known consumer data hub comprises a plurality of known records each pertaining to one of the plurality of consumers wherein each record comprises a consumer link;
c. an anonymous consumer data hub in communication with the data layer, wherein the anonymous data hub comprises a plurality of anonymous records each pertaining to one of the plurality of consumers wherein each record comprises an anonymous link; and
d. a decision engine in communication with each of the known consumer data hub and the anonymous consumer data hub.

2. The system for determining a next best offer of claim 1, wherein the decision engine is operable to deliver a next best offer through a marketing channel to a consumer device.

3. The system for determining a next best offer of claim 1, wherein the anonymous consumer data hub excludes personally identifiable information (PII) in the anonymous records.

4. The system for determining a next best offer of claim 1, wherein the data layer comprises transaction data.

5. The system for determining a next best offer of claim 1, wherein the data layer comprises past campaign response data.

6. The system for determining a next best offer of claim 1, wherein the data layer comprises demographic data.

7. The system for determining a next best offer of claim 1, wherein the data layer comprises marketing services provider (MSP) proprietary data.

8. The system for determining a next best offer of claim 7, wherein the MSP proprietary data comprises at least one of predictive or propensity data.

9. The system for determining a next best offer of claim 1, wherein the data layer comprises real-time data.

10. The system for determining a next best offer of claim 9, wherein the real-time data comprises website clickstream data.

11. The system for determining a next best offer of claim 1, further comprising an MSP routine to read an MSP cookie from an MSP cookie store at a consumer device.

12. The system for determining a next best offer of claim 1, wherein the MSP routine is further configured to determine an anonymous link from the MSP cookie.

13. A computer-implemented method for determining a next best offer, comprising the steps of:
a. receiving at a decision engine at a marketing services provider (MSP) a request to construct a next best offer comprising a marketing message;
b. determining whether the request comprises personally identifiable information (PII);
c. accessing a known consumer data hub from the decision engine if PII is used in the next best offer request, or accessing an anonymous consumer data hub from the decision engine if PII is not used in the next best offer request; and
d. delivering the marketing message to a marketing channel in communication with a consumer device.

14. The method for determining a next best offer of claim 13, further comprising the step of constructing the known consumer data hub and the anonymous consumer data hub utilizing a data layer comprising a plurality of data sources.

15. The method for determining a next best offer of claim 14, wherein the step of accessing a known consumer data hub comprises the step of searching a plurality of known consumer records each comprising a consumer link.

16. The method for determining a next best offer of claim 15, wherein the step of accessing an anonymous consumer data hub comprises the step of searching a plurality of anonymous consumer records each comprising an anonymous link.
